(19) United States
(12) Patent Application Publication
(10) Pub. No.: US 2025/0066563 A1
(43) Pub. Date: Feb. 27, 2025

(54) GLASS FIBER-REINFORCED THERMOPLASTIC POLYMER COMPOSITION

(71) Applicant: SABIC GLOBAL TECHNOLOGIES B.V., Bergen op Zoom (NL)

(72) Inventors: Tariq SYED, Novi, MI (US); Robert Russell GALLUCCI, Mount Vernon, IN (US); Remco BOS, Sittard (NL); Angelo CRAS, Genk (BE); Jose SALES FERNANDEZ, Maastricht (NL)

(21) Appl. No.: 18/724,330

(22) PCT Filed: Dec. 16, 2022
(86) PCT No.: PCT/EP2022/086272

§ 371 Date: Jun. 26, 2024

(30) Foreign Application Priority Data
Dec. 28, 2021 (EP) 21217918.8

(51) Int. Cl. C08J 5/08; C08G 63/183; C08J 5/24; C08K 5/544; C08K 7/14; C08L 23/26

(52) U.S. Cl. CPC C08J 5/08; C08G 63/183; C08J 5/244; C08K 5/544; C08K 7/14; C08L 23/26; C08J 2367/02; C08J 2391/06; C08L 2203/12

(57) ABSTRACT

A glass fiber-reinforced thermoplastic polymer composition has a sheathed continuous multifilament strand including a core that extends in the longitudinal direction and a polymer sheath which intimately surrounds the core, wherein the core has an impregnated continuous multifilament strand having at least one continuous glass multifilament strand, wherein the at least one continuous glass multifilament strand is impregnated with an impregnating agent, the polymer sheath is a thermoplastic polymer composition including a thermoplastic polymer, wherein the thermoplastic polymer contains a polyester having a weight average molecular weight of 15,000 to 80,000 Daltons as measured by gel permeation chromatography (GPC) using polystyrene standard and as measured by differential scanning calorimetry with a heating rate of 20° C./minute on first heating according to ASTM D3418-08, at least one crystalline melting point (Tm) of 200 to 290° C.

### CROSS REFERENCE TO RELATED APPLICATIONS

This application is a National Stage application of PCT/EP2022/086272, filed Dec. 16, 2022, which claims the benefit of European Application No. 21217918.8, filed Dec. 28, 2021, both of which are incorporated by reference in their entirety herein.

### BACKGROUND

The present invention relates to a glass fiber-reinforced thermoplastic polymer composition and a process for producing such composition. The present invention further relates a molded article comprising such composition.

Reinforcement of thermoplastic polymer compositions by glass fibers is known. It is known to use short glass fibers and long glass fibers. Articles made from short glass fiber-reinforced thermoplastic polymer composition have their advantages, but articles made from long glass fiber-reinforced thermoplastic polymer composition generally have better stiffness and impact strength as explained in Thomason & Vlug, Comp Part A, 1996, p. 1075-1084.

A long glass fiber-reinforced thermoplastic polymer composition such as STAMAX™ materials available from SABIC can be made by a process comprising subsequent steps of unwinding from a package of a continuous glass multifilament strand and applying a sheath of polypropylene around said multifilament strand to form a sheathed continuous multifilament strand.

Such process is known from WO2009/080281. This published patent application discloses a process for producing a long glass fiber-reinforced thermoplastic polymer composition, which comprises the subsequent steps of i) unwinding from a package of at least one continuous glass multifilament strand, ii) applying an impregnating agent to said at least one continuous glass multifilament strand to form an impregnated continuous multifilament strand, and iii) applying a sheath of thermoplastic polymer around the impregnated continuous multifilament strand to form a sheathed continuous multifilament strand.

While the known long glass fiber-reinforced thermoplastic polymer composition are satisfactory for use in many applications, there is a demand for a composition which can be used in a broader range of situations.

### SUMMARY

It is an objective of the present invention to provide a glass fiber-reinforced thermoplastic polymer composition comprising a sheathed continuous multifilament strand, which can be further processed at higher temperatures than known glass fiber-reinforced polypropylene compositions.

Accordingly, the invention provides a glass fiber-reinforced thermoplastic polymer composition comprising a sheathed continuous multifilament strand comprising a core that extends in the longitudinal direction and a polymer sheath which intimately surrounds said core,
wherein the core comprises an impregnated continuous multifilament strand comprising at least one continuous glass multifilament strand, wherein the at least one continuous glass multifilament strand is impregnated with an impregnating agent,
wherein the polymer sheath consists of a thermoplastic polymer composition comprising a thermoplastic polymer,
wherein the thermoplastic polymer comprises a polyester having
a weight average molecular weight of 15,000 to 80,000 Daltons as measured by gel permeation chromatography (GPC) using polystyrene standard and
as measured by differential scanning calorimetry with a heating rate of 20° C./minute on first heating according to ASTM D3418-08, at least one crystalline melting point (Tm) of 200 to 290° C.

The invention further provides a process for the production of the glass fiber-reinforced thermoplastic polymer composition according to the invention, wherein the sheathed continuous multifilament strand is prepared by the sequential steps of
a) unwinding from a package of the at least one continuous glass multifilament strand,
b) applying the impregnating agent to the at least one continuous glass multifilament strand to form the impregnated continuous multifilament strand and
c) applying the sheath of the thermoplastic polymer composition around the impregnated continuous multifilament strand to form the sheathed continuous multifilament strand.

Details relevant to steps a)-c) are described in WO2009/080281A1 except for the type of the thermoplastic polymer composition used according to the present invention, which document is hereby incorporated by reference.

The process for the production of the glass fiber-reinforced thermoplastic polymer composition according to the invention may further comprise the step of
d) cutting the sheathed continuous glass multifilament strand into pellets.

### DETAILED DESCRIPTION

It was surprisingly found by the present inventors that the glass fiber-reinforced thermoplastic polymer composition according to the invention can be made by using a polyester having a certain molecular weight and a certain crystalline melting point. The composition according to the invention e.g. in the form of pellets can be further processed, e.g. by injection molding, at higher temperatures than known pellets of a glass fiber-reinforced polypropylene composition. This is advantageous in that the higher temperatures reduce shear stress at die, which helps to reduce melt fracture. Further, polyester is a low friction material, which helps to reduce die swell. Further, the composition according to the invention crystallizes fast, requiring less time for obtaining the pellets than pellets made of polyolefins.

The glass fiber-reinforced thermoplastic polymer composition according to the invention shows superior heat resistance, as shown e.g. by Vicat temperatures above 200° C. for example as measured by ISO 306/A with a 10N load. This allows lighter weight plastic parts that can be painted alongside of metal parts facilitating processes such as efficient automotive body construction; for example E-coat painting. Poly butylene terephthalate (PBT) is especially useful as its rapid crystallization allows parts to be molded quickly with little or no dimensional change during additional heat exposure. PBT also has excellent chemical resistance to fuels and fluids and can easily be recycled by heating above its crystalline melting point.

### Sheathed Continuous Multifilament Strand

The glass fiber-reinforced thermoplastic polymer composition according to the invention, which may be in the form of pellets, comprises or consists of the sheathed continuous multifilament strand. The sheathed continuous multifilament strand comprises or consists of a core and a polymer sheath. The core has a generally cylindrical shape and comprises an impregnated continuous multifilament strand comprising glass filaments. The core is intimately surrounded around its circumference by a polymer sheath having a generally tubular shape and consisting of a thermoplastic polymer composition. The glass filaments have a length substantially equal to the axial length of the pellet.

The core does not substantially contain the material of the sheath. The sheath is substantially free of the glass filaments. Such a pellet structure is obtainable by a wire-coating process such as for example disclosed in WO 2009/080281 and is distinct from the pellet structure that is obtained via the typical pultrusion type of processes such as disclosed in U.S. Pat. No. 6,291,064.

Preferably, the polymer sheath is substantially free of the glass filaments, meaning it comprises less than 2 wt % of the glass filaments based on the total weight of the polymer sheath.

Preferably, the radius of the core is between 800 and 4000 micrometer and/or the thickness of the polymer sheath is between 500 and 1500 micrometer.

Preferably, the core comprises between 35 and 60% of the cross section area of the pellet and the sheath comprises between 40 and 65% of the cross section area of the pellet.

Preferably, the amount of the impregnated continuous multifilament strand is 10 to 70 wt %, for example 15 to 60 wt %, 20 to 50 wt % or 25 to 45 wt %, with respect to the sheathed continuous multifilament strand. Preferably, the amount of the thermoplastic composition is 30 to 90 wt %, for example 40 to 85 wt %, 50 to 80 wt % or 55 to 75 wt %, with respect to the sheathed continuous multifilament strand. Preferably, the total amount of the impregnated continuous multifilament strand and the thermoplastic composition is 100 wt % with respect to the sheathed continuous multifilament strand.

### Polymer Sheath

The sheath intimately surrounds the core. The term intimately surrounding as used herein is to be understood as meaning that the polymer sheath substantially entirely contacts the core. Said in another way the sheath is applied in such a manner onto the core that there is no deliberate gap between an inner surface of the sheath and the core containing the impregnated continuous multifilament strands. A skilled person will nevertheless understand that a certain small gap between the polymer sheath and the core may be formed as a result of process variations.

The polymer sheath consists of a thermoplastic polymer composition.

### Thermoplastic Polymer Composition of Polymer Sheath

The thermoplastic polymer composition comprises a thermoplastic polymer. Preferably, the thermoplastic polymer composition consists of the thermoplastic polymer and additives described below.

### Thermoplastic Polymer in Thermoplastic Polymer Composition of Polymer Sheath

The amount of the thermoplastic polymer with respect to the thermoplastic polymer composition may be at least 50 wt %, for example 50 to 99.9 wt %, 75 to 99.9 wt % or 95 to 99 wt %.

### Polyester

The polyester in the thermoplastic polymer composition has a weight average molecular weight of 15,000 to 80,000 Daltons as measured by gel permeation chromatography (GPC) using polystyrene standard in an Agilent 1200 system equipped with PL HFIPgel column and Refractive Index detector. The sample is dissolved in 10% HFIP solution in chloroform and the same solvent is used as carrier.

It was surprisingly found by the inventor of the current invention that required arrange of the weight average molecular weight renders an optimal balance between the processibility of polyester in a wire-coating process and the impact performance of the fiber-reinforced thermoplastic polymer composition.

Further, the polyester in the thermoplastic polymer composition has, as measured by differential scanning calorimetry with a heating rate of 20° C./minute on first heating according to ASTM D3418-08, at least one crystalline melting point (Tm) of 200 to 290° C. and preferably an enthalpy of fusion of at least 10 J/g.

The polyester in the thermoplastic polymer composition may have an intrinsic viscosity of 0.4 to 2.0 dL/g, preferably 0.5 to 1.0 dL/g, measured in a 60:40 by weight phenol/1,1,2,2-tetrachloroethane mixture at 23° C.

The polyester in the thermoplastic polymer composition may have a carboxylic acid (COOH) end group content of at least 20 ppm, as determined by potentiometric titration for example according to ASTM D7409-15.

The polyester in the thermoplastic polymer composition may have a hydroxy (OH) end group content of at least 20 ppm as determined by ASTM D4274-21.

The ratio of the hydroxy end group content to the carboxylic acid (COOH) end group content may be at least 1.3.

The polyester in the thermoplastic polymer composition may have a total content of Ti, Zr, Zn, Sb, Ge and Sn of 10 to 200 ppm and a total content of Pb, Cd, As and Hg of less than 1 ppm, as determined by inductively coupled plasma optical emission spectrometry (ICP-OES) for example according to ISO 24047:2021.

Preferably, the amount of the polyester with respect to the total thermoplastic polymer in the thermoplastic polymer composition is at least 80 wt %, for example at least 90 wt %, at least 93 wt %, at least 95 wt %, at least 97 wt % at least 98 wt % or at least 99 wt %. The thermoplastic polymer in the thermoplastic polymer composition may consist of the polyester.

In some preferred embodiments, the amount of the polyester with respect to the thermoplastic polymer composition may be at least 50 wt %, for example 50 to 99.9 wt %, 75 to 99.9 wt % or 95 to 99 wt %.

Polyesters for use in the present thermoplastic compositions have repeating structural units of formula (I)

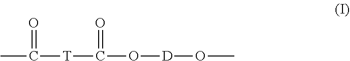

wherein each T is independently the same or different divalent C₆₋₁₀ aromatic group derived from a dicarboxylic acid or a chemical equivalent thereof, and each D is independently a divalent C₂₋₄ alkylene group derived from a dihydroxy compound or a chemical equivalent thereof. Copolyesters containing a combination of different T and/or D groups can be used. Chemical equivalents of diacids include the corresponding esters, alkyl esters, e.g., C₁₋₃ dialkyl esters, diaryl esters, anhydrides, salts, acid chlorides, acid bromides, and the like. Chemical equivalents of dihydroxy compounds include the corresponding esters, such as C₁₋₃ dialkyl esters, diaryl esters, and the like. The polyesters can be branched or linear. Exemplary polyesters include poly(alkylene terephthalates) (“PAT”) for example, poly(1,4-butylene terephthalate), (“PBT”), poly(ethylene terephthalate) (“PET”), poly(ethylene naphthalate) (“PEN”), poly(butylene naphthalate), (“PBN”), poly(propylene terephthalate) (“PPT”), poly(cyclohexane dimethanol terephthalate) (“PCT”), poly(cyclohexane-1,4-dimethylene cyclohexane-1,4-dicarboxylate) also known as poly(1,4-cyclohexanedimethanol 1,4-dicarboxylate) (“PCCD”), poly(cyclohexanedimethanol terephthalate), poly(cyclohexylenedimethylene-co-ethylene terephthalate), cyclohexanedimethanol-terephthalic acid-isophthalic acid copolymers and cyclohexanedimethanol-terephthalic acid-ethylene glycol (“PCTG” or “PETG”) copolymers. When the molar proportion of cyclohexanedimethanol is higher than that of ethylene glycol the polyester is termed PCTG. When the molar proportion of ethylene glycol is higher than that of cyclohexane dimethanol the polyester is termed PETG. Crystalline polyalkylene terephthalates alone or in admixture are preferred.

The polyesters can be obtained by methods well known to those skilled in the art, including, for example, interfacial polymerization, melt-process condensation, solution phase condensation, and transesterification polymerization. Such polyesters are typically obtained through the condensation or ester interchange polymerization of the diol or diol equivalent component with the diacid or diacid chemical equivalent component. Methods for making polyesters and the use of polyesters in thermoplastic molding compositions are known in the art. Conventional polycondensation procedures are described in the following, see, generally, U.S. Pat. Nos. 2,465,319, 5,367,011 and 5,411,999. The condensation reaction can be facilitated by the use of a catalyst, with the choice of catalyst being determined by the nature of the reactants. The various catalysts are known in the art. For example, a dialkyl ester such as dimethyl terephthalate can be transesterified with butylene glycol using acid catalysis, to generate poly(butylene terephthalate). It is possible to use a branched polyester in which a branching agent, for example, a glycol having three or more hydroxyl groups or a trifunctional or multifunctional carboxylic acid has been incorporated.

Preferably, the polyester comprises a PBT.

PBT has desirable properties such as good flexural properties, drawability and chemical resistance. PBT crystallizes rapidly and thus allows fast injection molding, faster e.g. than PET.

Preferably, the amount of the PBT with respect to the total polyester in the thermoplastic polymer composition is at least 80 wt %, for example at least 90 wt %, at least 93 wt %, at least 95 wt %, at least 97 wt % at least 98 wt % or at least 99 wt %. The polyester in the thermoplastic polymer composition may consist of the PBT.

Commercial examples of PBT include those available under the trade names VALOX VALOX 195 and VALOX 315 and 334, manufactured by SABIC Innovative Plastics.

In some embodiments, the polyester in the thermoplastic polymer composition consists of a PBT and a polyester selected from the group consisting of a poly(ethylene terephthalate), poly(ethylene naphthalate), poly(1,4-butylene naphthalate), poly(trimethylene terephthalate), poly(1,4-cyclohexanenedimethylene 1,4-cyclohexanedicarboxylate), poly(1,4-cyclohexanedimethylene terephthalate), poly(1,4-butylene-co-1,4-but-2-ene diol terephthalate), poly(cyclohexanedimethylene-co-ethylene terephthalate) and combinations thereof. In some preferred embodiments, the polyester in the thermoplastic polymer composition consists of a PBT and a PET. The weight ratio of PBT:other polyester can vary from 50:50 to 99:1, specifically from 80:20 to 99:1. This may lower the cost, facilitate the use of post consumer recycle (PCR) while suitably adjusting the mechanical properties. In such instances blends with higher PBT content with fast crystallization may be preferred for injection molding applications.

The polyesters in the thermoplastic polymer composition may be a combination of polyesters having different intrinsic viscosities and/or weight average molecular weights. For example, the polyesters in the thermoplastic polymer composition may comprise a first polyester having an intrinsic viscosity from 0.5 to 1.0 dL/g and a second polyester having an intrinsic viscosity ranging from 1.1 to 1.4 dL/g. One or both of the polyesters can be a PBT. The intrinsic viscosity is determined in accordance with ASTM D2857-95 (2007), the solvent is 1:1 weight to weight mixture of phenol:1,1,2,2-tetrachloro ethane at 30° C. The weight ratio of the two polyesters of different viscosity can be adjusted to achieve the desired properties, and is generally within the range of 20:80 to 80:20, more specifically from 40:60 to 60:40.

### Further Polymers

The thermoplastic polymer may comprise a further polymer preferably selected from a polycarbonate and an acrylonitrile butadiene styrene (ABS) and their combination.

Preferably, the amount of the further polymer with respect to the total thermoplastic polymer in the thermoplastic polymer composition is 1 to 20 wt %.

The presence of the polycarbonate is advantageous for improving toughness, high temperature modulus and load bearing capability.

The presence of the ABS rubber is advantageous for improving lower temperature toughness and polymer melt elasticity.

### Additives in Thermoplastic Polymer Composition of Polymer Sheath

The thermoplastic polymer composition of the polymer sheath may contain other usual additives, for instance nucleating agents and clarifiers, stabilizers, fillers, plasticizers, anti-oxidants, lubricants, antistatics, scratch resistance agents, impact modifiers, acid scavengers, recycling additives, coupling agents, anti-microbials, anti-fogging additives, slip additives, anti-blocking additives, polymer processing aids, flame retardants, colorants and the like. Such additives are well known in the art. The skilled person will know how to choose the type and amount of additives such that they do not detrimentally influence the aimed properties. The amount of the additives may e.g. be 0.1 to 50 wt % of the thermoplastic polymer composition, for example 0.1 to 25 wt % or 1.0 to 5.0 wt %.

In some preferred embodiments, the additives in the thermoplastic polymer composition of the polymer sheath comprises a coupling agent.

Suitable examples of the coupling agent include a functionalized polyolefin grafted with an acid or acid anhydride functional group. The polyolefin is preferably polyethylene or polypropylene, more preferably polypropylene. The polypropylene may be a propylene homopolymer or a propylene copolymer. The propylene copolymer may be a propylene-α-olefin copolymer consisting of at least 70 wt % of propylene and up to 30 wt % of α-olefin, for example ethylene, for example consisting of at least 80 wt % of propylene and up to 20 wt % of α-olefin, for example consisting of at least 90 wt % of propylene and up to 10 wt % of α-olefin, based on the total weight of the propylene-based matrix. Preferably, the α-olefin in the propylene-α-olefin copolymer is selected from the group of α-olefins having 2 or 4-10 carbon atoms and is preferably ethylene. Examples of the acid or acid anhydride functional groups include (meth)acrylic acid and maleic anhydride. A particularly suitable material is for example maleic acid functionalized propylene homopolymer (for example Exxelor PO 1020 supplied by Exxon).

The amount of the coupling agent may e.g. be 0.5 to 3.0 wt %, preferably 1.0 to 2.0 wt %, based on the sheathed continuous multifilament strand.

In some preferred embodiments, the additives in the thermoplastic polymer composition of the polymer sheath comprises a flame retardant. The flame retardant may comprise an organic flame retardant and/or an inorganic flame retardant.

In some preferred embodiments, the amount of the flame retardant, in particular the organic flame retardant, with respect to thermoplastic polymer composition of the polymer sheath is 0.1 to 50 wt %, e.g. at least 1.0 wt %, at least 5.0 wt %, at least 10 wt %, at least 20 wt %, at least 30 wt % and/or at most 45 wt % or at most 40 wt %.

### Core

The sheathed continuous multifilament strand comprises a core that extends in the longitudinal direction. The core comprises an impregnated continuous multifilament strand comprising at least one continuous glass multifilament strand, wherein the at least one continuous glass multifilament strand is impregnated with an impregnating agent. The impregnated continuous multifilament strand is prepared from a continuous glass multifilament strand and an impregnating agent.

Preferably, the at least one impregnated continuous multifilament strands form at least 90 wt %, more preferably at least 93 wt %, even more preferably at least 95 wt %, even more preferably at least 97 wt %, even more preferably at least 98 wt %, for example at least 99 wt % of the core. In a preferred embodiment, the core consists of the at least one impregnated continuous multifilament strand.

In the context of the invention with ‘extends in the longitudinal direction’ is meant ‘oriented in the direction of the long axis of the sheathed continuous multifilament strand’.

### Glass Filaments of Sheathed Continuous Multifilament Strand of Core

The continuous multifilament strand comprises glass filaments. Glass fibres are generally supplied as a plurality of continuous, very long filaments, and can be in the form of strands, rovings or yarns. A filament is an individual fibre of reinforcing material. A strand is a plurality of bundled filaments. Yarns are collections of strands, for example strands twisted together. A roving refers to a collection of strands wound into a package.

For purpose of the invention, a glass multifilament strand is defined as a plurality of bundled glass filaments.

Glass multifilament strands and their preparation are known in the art.

The filament density of the continuous glass multifilament strand may vary within wide limits. For example, the continuous glass multifilament strand may have a density of 1000 to 10000 grams per 1000 meter.

Preferably, the continuous glass multifilament strand has a density of 1000 to 2900 grams per 1000 meter, more preferably 1500 to 2800 grams per 1000 meter.

The continuous glass multifilament strand may have a filament diameter of 5 to 50 μm, more preferably from 10 to 30 μm, even more preferably from 15 to 25 μm. Usually the glass filaments are circular in cross section meaning the thickness as defined above would mean diameter. The glass filaments are generally circular in cross section.

Preferably, the ratio between the length of the glass fibers and the diameter of the glass fibers (L/D ratio) in the pellets is 500 to 1000.

The length of the glass filaments is in principle not limited as it is substantially equal to the length of the sheathed continuous multifilament strand. For practical reasons of being able to handle the strand however, it may be necessary to cut the sheathed continuous multifilament strand into a shorter strand. For example the length of the sheathed continuous multifilament strand is at least 1 m, for example at least 10 m, for example at least 50 m, for example at least 100 m, for example at least 250 m, for example at least 500 m and/or for example at most 25 km, for example at most 10 km.

Preferably, the glass multifilament strand is coated with a sizing composition (i.e., a coating) to improve adhesion to the polymer matrix. The sizing composition can be disposed on substantially all of the glass filaments or on a portion of the glass filaments in the thermoplastic composition. The sizing provides coated glass filaments that can be either bonding or non-bonding towards the thermoplastic polymer composition of the sheath. Preferably, the coated glass filaments are bonding towards the polyester in the thermoplastic polymer composition of the sheath.

The sizing composition can include a polyepoxide, a poly(meth)acrylate, a poly(arylene ether), a polyurethane, or a combination thereof. The polyepoxide can be a phenolic epoxy resin, an epoxylated carboxylic acid derivative (e.g., a reaction product of an ester of a polycarboxylic acid having one or more unesterified carboxyl groups with a compound including more than one epoxy group), an epoxidized diene polymer, an epoxidized polyene polymer, or a combination thereof.

The sizing composition can further include a silane coupling agent to facilitate bonding with the glass fiber. The silane coupling agent can be tri(C₁₋₆ alkoxy) mono amino silane, tri(C₁₋₆ alkoxy)diamino silane, tri(C₁₋₆ alkoxy)(C₁₋₆ alkyl ureido) silane, tri(C₁₋₆ alkoxy)(epoxy C₁₋₆ alkyl) silane, tri(C₁₋₆ alkoxy)(glycidoxy C₁₋₆ alkyl) silane, tri(C₁₋₆ alkoxy)(mercapto C₁₋₆ alkyl) silane, or a combination thereof. For example, the silane coupling agent is (3-aminopropyl)triethoxy silane, (3-glycidoxypropyl)trimethoxysilane, (2-(3,4-epoxycyclohexyl)ethyl)triethoxysilane, (3-mercaptopropyl)trimethoxysilane, (3-(2-aminoethylamino)propyl)triethoxysilane, (3-ureidopropyl)triethoxy silane, or a combination thereof. Preferably, the silane coupling agent is aminopropyltriethoxysilane, glycidylpropyltrimethoxysilane, or a combination thereof.

Other materials that can be included in the sizing composition include, but are not limited to, anti-static agents, coupling agents, lubricants, wetting agents, or the like.

The sizing composition can be present in an amount from 0.1 to 5 wt % based on the weight of the at least one continuous glass multifilament strand. The sizing composition may be applied to the glass fibers by any means, such as immersing the glass multifilament strand in the sizing composition or contacting the glass multifilament strand with an aqueous emulsion, or suspension of the sizing composition. Other coating methods include using an aqueous dispersion of the sizing composition applied to the uncoated glass multifilament strand by a roller in a continuous fashion, which can be followed by a heat treatment or curing step.

Typically, after applying the sizing composition to the glass filaments, the filaments are bundled into the continuous glass multifilament strands and then wound onto bobbins to form a package.

Preferably, the amount of the at least one continuous glass multifilament strand is 10 to 70 wt %, for example 15 to 60 wt %, 20 to 50 wt % or 25 to 45 wt %, with respect to the sheathed continuous multifilament strand.

### Impregnating Agent

The impregnated continuous multifilament strand is prepared from a continuous glass multifilament strand and an impregnating agent and in particular by applying an impregnating agent to the continuous glass multifilament strand preferably in an amount from 0.50 to 18.0 wt % with respect to the sheathed continuous multifilament strand.

Preferably, the amount of the impregnating agent with respect to the sheathed continuous multifilament strand is 1.0 to 10.0 wt %, particularly 2.5 to 5.0 wt %. This results in a particularly good impact strength of the composition according to the invention.

For example, the weight ratio of impregnating agent to continuous glass multifilament strand is in the range from 1:4 to 1:30, preferably in the range from 1:5 to 1:20, more preferably 1:6 to 1:13.

Preferably, the impregnating agent contains microcrystalline wax, preferably at an amount of at least 70 wt % of based on the weight of the impregnating agent. In that respect it is to be understood that the microcrystalline wax may be a single microcrystalline wax or a blend of several microcrystalline waxes.

Microcrystalline waxes are well known materials and are described in detail in e.g. WO2015/062825, p 5, l. 17-p. 7, l. 9, incorporated herein by reference. In general a microcrystalline wax is a refined mixture of solid saturated aliphatic hydrocarbons, and produced by de-oiling certain fractions from the petroleum refining process. Microcrystalline waxes differ from refined paraffin wax in that the molecular structure is more branched and the hydrocarbon chains are longer (higher molecular weight). As a result the crystal structure of microcrystalline wax is much finer than paraffin wax, which directly impacts many of the mechanical properties of such materials. Microcrystalline waxes are tougher, more flexible and generally higher in melting point compared to paraffin wax. The fine crystalline structure also enables microcrystalline wax to bind solvents or oil and thus prevents the sweating out of compositions. Microcrystalline wax may be used to modify the crystalline properties of paraffin wax.

Microcrystalline waxes are also very different from so called iso-polymers. First of all, microcrystalline waxes are petroleum based whereas iso-polymers are poly-alpha-olefins. Secondly iso-polymers have a very high degree of branching of above 95%, whereas the amount of branching for microcrystalline waxes generally lies in the range of from 40-80 wt %. Finally, the melting point of iso-polymers generally is relatively low compared to the melting temperature of microcrystalline waxes. All in all, microcrystalline waxes form a distinct class of materials not to be confused either by paraffin or by iso-polymers.

The impregnating agent may further contain a natural or synthetic wax or an iso-polymer, preferably at an amount of at most 30 wt % with respect to the impregnating agent. Typical natural waxes are animal waxes such as bees wax, lanolin and tallow, vegetable waxes such as carnauba, candelilla, soy, mineral waxes such as paraffin, ceresin and montan. Typical synthetic waxes include ethylenic polymers such as polyethylene wax or polyol ether-ester waxes, chlorinated naphtalenes and Fisher Tropsch derived waxes. A typical example of an iso-polymer, or hyper-branched polymer, is Vybar 260 mentioned above. In an embodiment the remaining part of the impregnating agent contains or consists of one or more of a highly branched poly-alpha-olefin, such as a polyethylene wax, paraffin.

In a preferred embodiment the impregnating agent comprises at least 80 wt %, more preferably at least 90 wt % or even at least 95 wt % or at least 99 wt % of microcrystalline wax. It is most preferred that the impregnating agent substantially consists of microcrystalline wax. In an embodiment the impregnating agent does not contain paraffin. The term substantially consists of is to be interpreted such that the impregnating agent comprises at least 99.9 wt % of microcrystalline wax, based on the weight of the impregnating agent.

The microcrystalline wax preferably has one or more of the following properties:
a drop melting point of from 60 to 90° C. as determined in accordance with ASTM D127
a congealing point of from 55 to 90° C. as determined in accordance with ASTMD938
a needle pen penetration at 25° C. of from 7 to 40 tenths of a mm as determined in accordance with ASTM D1321
a viscosity at 140° C. of from 10 to 25 mPa·s as determined in accordance with ASTM D445

In an even more preferred embodiment the microcrystalline wax has all these properties in combination.

The microcrystalline wax preferably further has:
an oil content of from 0 to 5 wt % preferably from 0 to 2 wt % based on the weight of the microcrystalline wax as determined in accordance with ASTM D721

Preferably, the viscosity of the impregnating agent is in the range from 2.5 to 200 mm²/s at 160° C., more preferably at least 5.0 mm²/s, more preferably at least 7.0 mm²/s and/or at most 150.0 mm²/s, preferably at most 125.0 mm²/s, preferably at most 100.0 mm²/s at 160° C., measured according to ASTM D445.

Any method known in the art may be used for applying the liquid impregnating agent to the continuous glass multifilament strand. The application of the liquid impregnating agent may be performed using a die. Other suitable methods for applying the impregnating agent to the continuous multifilament strands include applicators having belts, rollers, and hot melt applicators. Such methods are for example described in documents EP0921919B1, EP0994978B1, EP0397505B1, WO2014/053590A1 and references cited therein. The method used should enable application of a constant amount of impregnating agent to the continuous multifilament strand.

Preferably, the amount of the impregnated continuous multifilament strand is 15 to 75 wt %, for example 20 to 65 wt %, 25 to 55 wt % or 30 to 50 wt %, with respect to the sheathed continuous multifilament strand. Preferably, the total amount of the impregnated continuous multifilament strand and the polymer sheath is 100 wt % with respect to the sheathed continuous multifilament strand.

### Further Aspects

The invention provides pellets comprising or consisting of the glass fiber-reinforced thermoplastic polymer composition according to the invention.

The pellets may typically have a length of from 2 to 50 mm, preferably from 5 to 30 mm, more preferably from 6 to 20 and most preferably from 10 to 16 mm. The length of the glass fibers is typically substantially the same as the length of the pellet.

The total amount of the thermoplastic polymer composition and the impregnated continuous multifilament strand in the pellet is preferably at least 95 wt %, at least 98 wt %, at least 99 wt %, at least 99.9 wt % or 100 wt % with respect to the pellet.

The pellets according to the invention are preferably prepared by a process comprising the sequential steps of
a) unwinding from a package of the at least one continuous glass multifilament strand,
b) applying the impregnating agent to the at least one continuous glass multifilament strand to form the impregnated continuous multifilament strand and
c) applying the sheath of the thermoplastic polymer composition around the impregnated continuous multifilament strand to form the sheathed continuous multifilament strand and
d) cutting the sheathed continuous glass multifilament strand into pellets.

Step d) may be followed by a step of moulding the pellets into (semi-) finished articles. Suitable examples of moulding processes include injection moulding, compression moulding, extrusion and extrusion compression moulding. Injection moulding is widely used to produce articles such as automotive exterior parts like bumpers, automotive interior parts like instrument panels, or automotive parts under the bonnet. Extrusion is widely used to produce articles such rods, sheets and pipes. The article may have a wall thickness of e.g. 0.1 to 10 mm.

Accordingly, the present invention further relates to a molded article comprising the glass fiber-reinforced thermoplastic polymer composition or the pellets according to the invention, wherein the article is selected from automotive exterior parts like bumpers, automotive interior parts like instrument panels, and automotive parts under the bonnet.

The present invention further relates to process for making a molded article by molding the glass fiber-reinforced thermoplastic polymer composition or the pellets according to the invention, wherein the article is selected from automotive exterior parts like bumpers, automotive interior parts like instrument panels, and automotive parts under the bonnet. The step of moulding may be performed at temperatures above 230° C., for example 250 to 280° C.

It is noted that the invention relates to the subject-matter defined in the independent claims alone or in combination with any possible combinations of features described herein, preferred in particular are those combinations of features that are present in the claims. It will therefore be appreciated that all combinations of features relating to the composition according to the invention; all combinations of features relating to the process according to the invention and all combinations of features relating to the composition according to the invention and features relating to the process according to the invention are described herein.

It is further noted that the term ‘comprising’ does not exclude the presence of other elements. However, it is also to be understood that a description on a product/composition comprising certain components also discloses a product/composition consisting of these components. The product/composition consisting of these components may be advantageous in that it offers a simpler, more economical process for the preparation of the product/composition. Similarly, it is also to be understood that a description on a process comprising certain steps also discloses a process consisting of these steps. The process consisting of these steps may be advantageous in that it offers a simpler, more economical process.

The invention is now elucidated by way of the following examples, without however being limited thereto.

### Examples

### Materials Used

PP1: Polypropylene homopolymer with following properties: density: 905 kg/m³, melt flow rate (MFR): 47 dg/min at 230° C. and 2.16 kg (test method: ISO1133), melting point: 160-175° C.
PP2: Heterophasic propylene copolymer consisting of propylene homopolymer and propylene-ethylene copolymer with following properties: density: 905 kg/m³, melt flow rate (MFR): 70 dg/min at 230° C. and 2.16 kg (test method: ISO1133), melting point: 160-175° C.
PP3: Heterophasic propylene copolymer consisting of propylene homopolymer and propylene-ethylene copolymer with following properties: density: 905 kg/m³, melt flow rate (MFR): 15 dg/min at 230° C. and 2.16 kg (test method: ISO1133), melting point: 160-175° C.
PBT1: Valox 195 from SABIC, intrinsic viscosity=0.66 dl/g, Mn=60000 g/mol, Mw=70000 g/mol, melting point: 215° C. PBT1 is according to the preferred embodiment of the invention.
Coupling agent 1: Exxelor PO1020 powder (PP-g-MA) from ExxonMobil: density: 900 kg/m³, melting point: 162° C., MFR: 430 dg/min at 230° C. and 2.16 kg (testing method: ASTM D1238)
LGF1: a glass roving having a diameter of 19 micron and a tex of 3000 (tex means grams glass per 1000 m) not containing a sizing composition comprising a silane coupling agent which is tri(C₁₋₆ alkoxy)monoamino silane, tri(C₁₋₆ alkoxy)diamino silane, tri(C₁₋₆ alkoxy)(C₁₋₆ alkyl ureido) silane, tri(C₁₋₆ alkoxy)(epoxy C₁₋₆ alkyl) silane, tri(C₁₋₆ alkoxy)(glycidoxy C₁₋₆ alkyl) silane, tri(C₁₋₆ alkoxy)(mercapto C₁₋₆ alkyl) silane, or a combination thereof
LGF2: a glass roving having a diameter of 17 micron and a tex of 2400 (tex means grams glass per 1000 m) containing a sizing composition comprising a silane coupling agent which is tri(C₁₋₆ alkoxy)monoamino silane, tri(C₁₋₆ alkoxy)diamino silane, tri(C₁₋₆ alkoxy)(C₁₋₆ alkyl ureido) silane, tri(C₁₋₆ alkoxy)(epoxy C₁₋₆ alkyl) silane, tri(C₁₋₆ alkoxy)(glycidoxy C₁₋₆ alkyl) silane, tri(C₁₋₆ alkoxy)(mercapto C₁₋₆ alkyl) silane, or a combination thereof
Impregnating agent 1: Dicera 13802 microcrystalline wax having the following properties
   a drop melting point of 81° C. as determined in accordance with ASTM D127
   a congealing point of from 63 to 70° C. as determined in accordance with ASTMD938
   a needle pen penetration at 25° C. of from 16 tenths of a mm as determined in accordance with ASTM D1321
   a viscosity at 140° C. of from 15 to 25 mPa·s as determined in accordance with ASTM D445
   a peak melt temperature of 51° C.
   acid value of 0.2 mgKOH/g
   a density at 20° C. of 0.91 g/cc
Impregnating agent 2: Pluronic F88 (tade name of BASF), a tri-block copolymer also knows as poloxamer. This material is characterized by the presence of hydrophobic poly(propylene oxide) (PPO) sandwiched between two blocks of hydrophilic poly(ethylene oxide) (PEO).
Stabilizer: Irganox® B 225 commercially available from BASF, blend of 50 wt % tris(2,4-ditert-butylphenyl)phosphite and 50 wt % pentaerythritol tetrakis [3-[3,5-di-tert-butyl-4-hydroxyphenyl]propionate]
Elastomer 1: Hytrel 4056 (tade name of DuPont), a low modulus grade of a poly(ether-ester) copolymer with nominal durometer hardness of 40D and with high impact resistance down to −40° C.

### Preparation of Sheathed Continuous Multifilament Strands (Wire-Coating)

Sheathed continuous multifilament strands were prepared using components given in Table 1 using the wire coating process as described in details in the examples of WO2009/080281A1. For Ex 2-8, the processing temperature was 250 to 280° C.

The impregnating agent was applied to LGF1 or LGF2 to obtain an impregnated continuous glass multifilament strand.

Thermoplastic polymer (PP or PBT), coupling agent and other additives shown in table 1 were fed to the extruder to sheath the impregnated continuous glass multifilament strand using an extruder-head wire-coating die. The sheathing step was performed in-line directly after the impregnating step. The obtained sheathed continuous multifilament strand was cut into pellets having length of 8-15 mm and diameter of 3-4 mm.

The compositions of Ex 2-8 made using PBT cured fully much faster than the compositions of CEx 1 made using PP.

Following properties were measured and are shown in Table 1.

| | | |
|---|---|---|
| Izod ISO 180/1A | ISO180/1A/T23II | Test geometry: 80*10*4 mm, |
| (II) @23° C. after | | Manual 20 V2021. |
| 7 days | | |
| Charpy ISO179/1eA | ISO179/1eA/T23II | Test geometry: 80*10*4 mm, |
| (II) @23° C. after | | Manual 10 V2021. |
| 7 days | | |
| Vicat A ISO 306/A | ISO306/A/120 | Heating rate: 120° C./hour, |
| (Load = 10N) | | Manual 80. |

TABLE 1

| | CEx 1 | Ex 2 | Ex 3 | Ex 4 | Ex 5 | Ex 6 | Ex 7 | Ex 8 |
|---|---|---|---|---|---|---|---|---|
| PP1 | 64.85 | | | | | | | |
| PP2 | | | | | | | | |
| PP3 | | | | | | | | |
| PBT1 | | 64.85 | 63.85 | 64.85 | 64.85 | 63.85 | 64.85 | 61.85 |
| Coupling agent 1 | 1.5 | 1.5 | 1.5 | 1.5 | 1.5 | 1.5 | 1.5 | 1.5 |
| LGF1 | 30.15 | 30.15 | 30.15 | 30.15 | | | | |
| LGF2 | | | | | 30.15 | 30.15 | 30.15 | 30.15 |
| Impregnating agent 1 | 3 | 3 | 2 | 0 | 3 | 2 | 0 | 2 |
| Impregnating agent 2 | 0 | 0 | 2 | 3 | 0 | 2 | 3 | 2 |
| Stabilizer 1 | 0.2 | 0.2 | 0.2 | 0.2 | 0.2 | 0.2 | 0.2 | 0.2 |
| Elastomer 1 | | | | | | | | 2 |
| N-Izod Impact | 20 | 31 | | 23 | 43 | 30 | 26 | 21 |
| (kJ/m2) | | | | | | | | |
| N-Charpy Impact | 24 | 30 | | 27 | 40 | 28 | 22 | 23 |
| (kJ/m2) | | | | | | | | |
| Force max energy (J) | 12.6 | 14.1 | | 10.4 | 16.5 | 12.9 | 9 | 8.8 |

The Vicat softening temperature of the compositions of Ex 2 to 8 was about 215° C. whereas that of the compositions of CEx 1 was about 165° C.

Further, it can be understood from the comparison of Ex 2 and Ex 5 that use of LGF2 containing a specific sizing composition leads to better mechanical properties than use of LGF1.

Further, it can be understood from the comparison of Ex 5, Ex 6 and Ex 7 that use of the impregnating agent 1 leads to better mechanical properties than use of impregnating agent 2 and a larger amount of the impregnating agent 1 leads to better mechanical properties.

Further, it can be understood from the comparison of Ex 6 and Ex 8 that the absence of Elastomer 1 leads to better mechanical properties.

1. A glass fiber-reinforced thermoplastic polymer composition comprising a sheathed continuous multifilament strand comprising a core that extends in the longitudinal direction and a polymer sheath which intimately surrounds said core,
wherein the core comprises an impregnated continuous multifilament strand comprising at least one continuous glass multifilament strand, wherein the at least one continuous glass multifilament strand is impregnated with an impregnating agent,
wherein the polymer sheath consists of a thermoplastic polymer composition comprising a thermoplastic polymer,
wherein the thermoplastic polymer comprises a polyester, having
a weight average molecular weight of 15,000 to 80,000 Daltons as measured by gel permeation chromatography (GPC) using polystyrene standard and
as measured by differential scanning calorimetry with a heating rate of 20° C./minute on first heating according to ASTM D3418-08, at least one crystalline melting point (Tm) of 200 to 290° C.

2. The glass fiber-reinforced thermoplastic polymer composition according to claim 1, wherein the at least one continuous glass multifilament strand comprises a sizing composition comprising a silane coupling agent which is tri(C₁₋₆ alkoxy)monoamino silane, tri(C₁₋₆ alkoxy)diamino silane, tri(C₁₋₆ alkoxy)(C₁₋₆ alkyl ureido) silane, tri(C₁₋₆ alkoxy)(epoxy C₁₋₆ alkyl) silane, tri(C₁₋₆ alkoxy)(glycidoxy C₁₋₆ alkyl) silane, tri(C₁₋₆ alkoxy)(mercapto C₁₋₆ alkyl) silane, or a combination thereof.

3. The glass fiber-reinforced thermoplastic polymer composition according to claim 1, wherein the impregnating agent comprises microcrystalline wax.

4. The glass fiber-reinforced thermoplastic polymer composition according to claim 1, wherein the amount of the impregnating agent with respect to the sheathed continuous multifilament strand is 2.5 to 5.0 wt %.

5. The glass fiber-reinforced thermoplastic polymer composition according to claim 1, wherein the continuous glass multifilament strand has a density of 1000 to 2900 grams per 1000 meter.

6. The glass fiber-reinforced thermoplastic polymer composition according to claim 1, wherein the polyester has at least one of:
a carboxylic acid (COOH) end group content of at least 20 ppm, as determined by ASTM D7409-15 and/or a hydroxy (OH) end group content of at least 20 ppm as determined by ASTM D4274-21, or
a total content of Ti, Zr, Zn, Sb, Ge and Sn of 10 to 200 ppm and a total content of Pb, Cd, As and Hg of less than 1 ppm, as determined by ISO 24047:2021.

7. The glass fiber-reinforced thermoplastic polymer composition according to claim 1, wherein the amount of the polyester with respect to the total thermoplastic polymer in the thermoplastic polymer composition is at least 80 wt %.

8. The glass fiber-reinforced thermoplastic polymer composition according to claim 1, wherein the polyester comprises poly(1,4-butylene terephthalate).

9. The glass fiber-reinforced thermoplastic polymer composition according to claim 1, wherein the thermoplastic polymer comprise a further polymer selected from a polycarbonate and an acrylonitrile butadiene styrene (ABS) and their combination.

10. The glass fiber-reinforced thermoplastic polymer composition according to claim 1, wherein the thermoplastic polymer composition of the polymer sheath comprises a maleic acid functionalized propylene homopolymer.

11. The glass fiber-reinforced thermoplastic polymer composition according to claim 1, wherein the amount of the impregnated continuous multifilament strand is 10 to 70 wt %, with respect to the sheathed continuous multifilament strand.

12. Pellets comprising the glass fiber-reinforced thermoplastic polymer composition according to claim 1.

13. A process for preparing the glass fiber-reinforced thermoplastic polymer composition according to claim 1, comprising the sequential steps of:
a) unwinding from a package of the at least one continuous glass multifilament strand,
b) applying the impregnating agent to the at least one continuous glass multifilament strand to form the impregnated continuous multifilament strand and
c) applying the sheath of the thermoplastic polymer composition around the impregnated continuous multifilament strand to form the sheathed continuous multifilament strand and optionally d) cutting the sheathed continuous glass multifilament strand into pellets.

14. A molded article comprising the glass fiber-reinforced thermoplastic polymer composition according to claim 1.

15. A process for making a molded article by molding the glass fiber-reinforced thermoplastic polymer composition according to claim 1 at a temperature of at least 230° C.

16. A molded article comprising the pellets of claim 12.

17. A process for making a molded article by molding the pellets of claim 12 at a temperature of at least 230° C.
